(19) United States
(12) Patent Application Publication
(10) Pub. No.: US 2021/0399282 A1
(43) Pub. Date: Dec. 23, 2021

(54) POROUS ZN METAL ELECTRODE FOR ZN BATTERIES

(71) Applicant: URBAN ELECTRIC POWER INC., Pearl River, NY (US)

(72) Inventors: Jinchao HUANG, Pearl River, NY (US); Sanjoy BANERJEE, Pearl River, NY (US); Alexander COUZIS, Pearl River, NY (US); Andrew NAUKAM, Pearl River, NY (US); Michael NYCE, Pearl River, NY (US); Gautam G. YADAV, Pearl River, NY (US)

(21) Appl. No.: 17/287,927

(22) PCT Filed: Oct. 24, 2019
(86) PCT No.: PCT/US2019/057847

§ 371 Date: Apr. 22, 2021

Related U.S. Application Data
(60) Provisional application No. 62/750,042, filed on Oct. 24, 2018.

(51) Int. Cl. H01M 4/24; H01M 4/42; H01M 4/66; H01M 50/417; H01M 50/426; H01M 50/449; H01M 4/36; H01M 4/04

(52) U.S. Cl. CPC H01M 4/244; H01M 4/42; H01M 4/662; H01M 50/417; H01M 2004/021; H01M 50/449; H01M 4/366; H01M 4/0404; H01M 4/043; H01M 50/426

(57) ABSTRACT

In some embodiments, a battery comprises an anode, a cathode, a separator disposed between the anode and the cathode, and an electrolyte in fluid communication with the anode, the cathode, and the separator. The anode can be a porous metallic zinc anode. The porous metallic zinc anode comprises pure zinc electrode, a substrate coated with zinc, a zinc substrate with a coating layer, or combinations thereof.

### CROSS-REFERENCE TO RELATED APPLICATIONS

This application claims the benefit of U.S. Provisional Application No. 62/750,042 filed on Oct. 24, 2018 and entitled “Porous Zn Metal Electrode for Zn Batteries,” which is incorporated herein by reference in its entirety for all purposes.

### STATEMENT REGARDING GOVERNMENTALLY SPONSORED RESEARCH OR DEVELOPMENT

Not applicable.

### BACKGROUND

This disclosure relates to batteries including electrochemical cells. Alkaline cells have been predominantly used as primary batteries. However, the one-time use of primary batteries results in large material wastage as well as undesirable environmental consequences. Also, potential economic losses can arise due to the significant imbalance between the energy that is required to manufacture these cells compared to the energy that can be actually stored. As a consequence, there is a clear advantage to provide rechargeable or secondary cells.

As a form of alkaline cells, zinc-anode batteries have dominated the primary battery market since its invention. However, the rechargeable version of this chemistry has met with only limited success. This is in part due to various problems with short cycle life and shorting that can occur with alkaline cells using zinc anodes.

### SUMMARY

In some embodiments, a battery comprises an anode, a cathode, a separator disposed between the anode and the cathode, and an electrolyte in fluid communication with the anode, the cathode, and the separator. The anode can be a porous metallic zinc anode. The porous metallic zinc anode comprises pure zinc electrode, a substrate coated with zinc, a zinc substrate with a coating layer, or combinations thereof.

In some embodiments, an anode comprises at least one layer comprising a porous metallic zinc. The porous metallic zinc anode can include a pure zinc electrode, a substrate coated with zinc, a zinc substrate with a coating layer, or combinations thereof. The porous metallic zinc anode can be formed into an expanded mesh, woven mesh, foam, foil, perforated foil, pierced foil, wire screen, or any combination thereof.

In some embodiments, a method of forming a battery comprises providing an anode comprising at least one layer comprising a porous metallic zinc, providing a cathode, disposing a separator between the anode and the cathode in a housing, and disposing an electrolyte within the housing in contact with the anode, the cathode, and the separator. The porous metallic zinc anode comprises pure zinc electrode, a substrate coated with zinc, a zinc substrate with a coating layer, or combinations thereof, and the porous metallic zinc anode is formed into an expanded mesh, woven mesh, foam, foil, perforated foil, pierced foil, wire screen, or any combination thereof.

These and other features will be more clearly understood from the following detailed description taken in conjunction with the accompanying claims.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 schematically illustrates a battery according to an embodiment.

FIG. 2 schematically illustrates an electrode according to an embodiment.

FIG. 3 schematically illustrates another battery according to another embodiment.

FIGS. 4A and 4B is a schematic presentation and cross section view of the electrode configuration according to an embodiment.

FIGS. 5A-5C is a schematic presentation and cross section view of the electrode configuration according to an embodiment.

FIG. 6 is a schematic presentation of the electrode configuration according to an embodiment.

FIG. 7 is a graph illustrating the capacity curves and the discharge end voltage curve vs. cycle number for a jelly rolled cylindrical cell with a Zn mesh electrode with copper mesh current collector.

FIG. 8 is a graph illustrating the capacity curves vs. cycle number for a prismatic cell containing a Zn mesh electrode with copper mesh current collector and cycling within the 2-electron capacity region of MnO₂.

FIG. 9 is a graph illustrating the voltage curves of the full cell potential and the anode auxiliary potential for a prismatic cell containing a Zn mesh electrode with copper mesh current collector and cycling within the 2-electron capacity region of MnO₂.

FIG. 10 is a graph illustrating the capacity curves and the discharge end voltage curve vs. cycle number for a prismatic cell with a Zn mesh electrode without any current collector.

### DESCRIPTION

In this disclosure, the terms “negative electrode” and “anode” are both used to mean “negative electrode.” Likewise, the terms “positive electrode” and “cathode” are both used to mean “positive electrode.” Reference to an “electrode” alone can refer to the anode, cathode, or both. Reference to the term “primary battery” (e.g., “primary battery,” “primary electrochemical cell,” or “primary cell”), refers to a cell or battery that after a single discharge is disposed of and replaced. Reference to the term “secondary battery” (e.g., “secondary battery,” “secondary electrochemical cell,” or “secondary cell”), refers to a cell or battery that can be recharged one or more times and reused.

The devices and methods described herein relates to the preparation of a metallic zinc electrode for use in primary and secondary zinc batteries. Zinc is a widely used anode material for aqueous batteries. It is universally applied with different cathode combinations, such as Zn/Air, Zn/NiOOH, alkaline Zn/MnO₂, Zn/Ag₂O, etc. This material is abundantly available, relatively cheap and nontoxic. It is reliable due to its high corrosion resistance and good chemical properties. More importantly, it has very desirable electrochemical characteristics. Zinc is an active metal element. Among electrode materials compatible with aqueous electrolytes, zinc has the most negative standard potential. It also provides very high specific and volumetric energy densities (theoretical capacity ˜820 mAh/g). All these advantages of zinc make it predominant as an anode material, especially for primary batteries, which have been commercially available for decades. Currently, Zn batteries are becoming attractive for large-scale energy storage applications. However, the Zn electrode is known to face a problem of short and unpredictable cycle life during charge and discharge cycling, especially at a high utilization. Various failure mechanisms of Zn electrode have been reported, the major problems being the electrode shape change, dendritic morphology growth and passivation of the electrode surface. The origin of these phenomena can be traced to the dissolution-precipitation reaction pathway of Zn during charge-discharge cycling. Its high solubility in electrolytes and rapid electrochemical kinetics are mainly responsible for the redistribution of Zn active material and the formation of unwanted morphologies.

In order to address these problems, a novel Zn electrode structure is disclosed herein that provides a high surface area for easy electrolyte accessibility and preserves a good conductive matrix when discharged. The devices and methods relate to the preparation of a metallic zinc electrode for use in primary and secondary zinc anode batteries. Battery cells containing such electrodes in either prismatic or jelly roll form are also provided.

In some embodiments, a method includes selecting a porous metallic zinc material for use as the anode for a zinc battery. The electrode material can be pure zinc or a substrate coated with zinc or a zinc substrate with a coating layer. The method further comprises using the zinc sheet alone as the electrode, or attaching the porous sheet to a current collector.

In some embodiments, a method includes selecting a cathode for the zinc battery. The cathode materials include, but are not limited to manganese oxide, nickel oxyhydroxide, silver oxide electrode, an air electrode, zinc intercalating materials, or any combinations thereof.

In some embodiments, a method includes selecting an electrolyte for the zinc battery. The electrolyte can be aqueous or nonaqueous, liquid or solid, organic or inorganic.

In some embodiments, a method for making a battery comprises a cathode, an anode, and a separator disposed between the anode and the cathode. The battery can be prismatic or cylindrical. The battery can be primary or secondary.

The work described in this disclosure mainly relates to the preparation of a porous metallic zinc electrode for use in primary and secondary zinc anode batteries. This porous electrode comprises a 3D structure of metallic zinc, with a highly open structure and a large surface area for an easy electrolyte accessibility. A higher utilization is achievable with such electrode design. This porous electrode is featured with an interconnected network of metallic zinc that helps with preserving a continuous conductive matrix for the electrode, which is beneficial for its long-term performance. This 3D porous structure further mitigates the problem of zinc dendritic growth by developing a more uniform reconstruction during charging. The present devices and methods can be used in both primary and secondary zinc anode battery cells. The cell can be prismatic or jelly rolled.

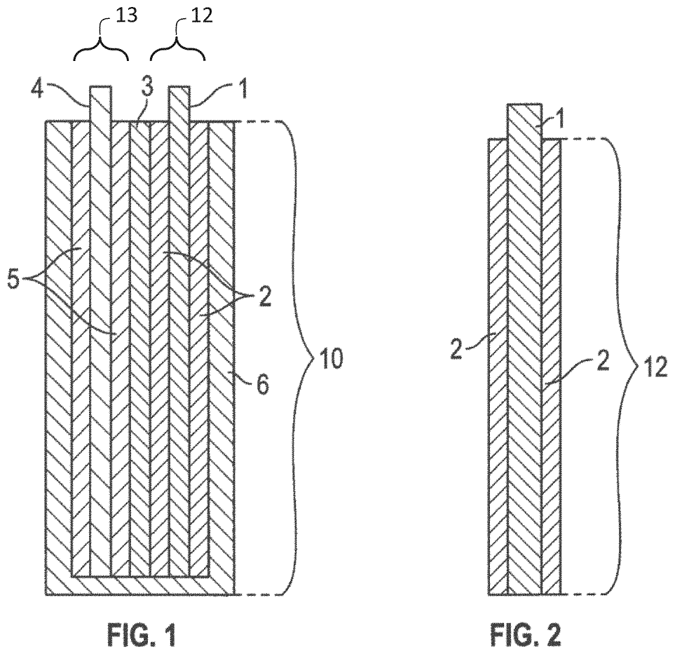

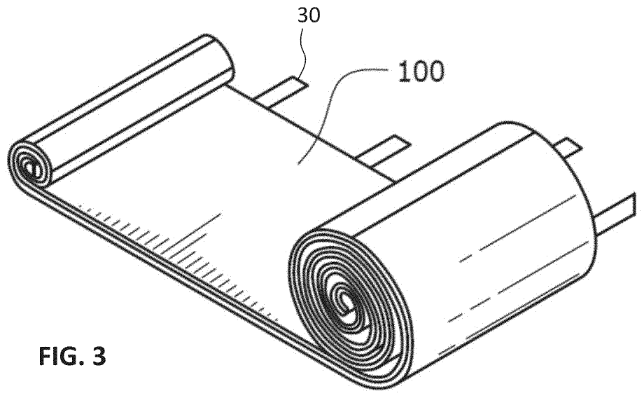

Referring to FIG. 1, a battery 10 can have a housing 6, a cathode 12, which can include a cathode current collector 1 and a cathode material 2, a separator 3, and an anode 13. In some embodiments, the anode 13 can comprise a current collector 4, and an anode material 5, though as described herein, some anodes may not have an anode current collector 4. FIG. 1 shows a prismatic battery arrangement. In another embodiment, the battery can be a cylindrical battery (e.g., as shown in FIG. 3) having the electrodes arranged concentrically or in a rolled configuration in which the anode and cathode are layered and then rolled to form a jelly roll configuration. An electrolyte can be dispersed in an open space throughout battery 10. The cathode current collector 1 and cathode material 2 are collectively called either the cathode 12 or the positive electrode 12, as shown in FIG. 2. Similarly, the anode material 5 with the optional anode current collector 4 can be collectively called either the anode 13 or the negative electrode 13.

In some embodiments, the battery 10 can comprise one or more cathodes 12 and one or more anodes 13. When a plurality of anodes 13 and/or cathodes 12 are present, the electrodes can be configured in a layered configuration such that the electrodes alternate (e.g., anode, cathode, anode, etc.). Any number of anodes 13 and/or cathodes 12 can be present to provide a desired capacity and/or output voltage. In the jellyrole configuration, the battery 10 may only have one cathode 12 and one anode 13 in a rolled configuration such that a cross section of the battery 10 includes a layered configuration of alternating electrodes.

The battery 10 comprises at least one anode 13 made of porous metallic zinc. The material for the porous zinc electrode can be pure zinc, a substrate coated by zinc, a zinc substrate with a coating layer, or a combination thereof. A pure zinc electrode can be in the form of one or more layers of an expanded mesh, a woven mesh, a zinc metal foam, a foil, a perforated foil, a pierced foil, a wire screen, or any combination thereof.

In some embodiments, the anode 13 can comprise a zinc coated substrate. The substrate materials can include, but are not limited to, metals (e.g., non-zinc based metals or alloys) such as nickel, copper, silver, gold, platinum, titanium, tin, iron, steel, aluminum, magnesium, bismuth, or combinations thereof (e.g., including alloys, compositions, etc.). In some embodiments, the substrate can comprise an organic substrate including polymers such as polyethylene, polypropylene, polyester, polyamide, cellulose acetate, cellophane, polyvinyl chloride, polyvinyl alcohol, or any combination thereof. The zinc coating layer can be applied by methods include but not limited to electrodeposition and/or electroless plating. The zinc coating can have a suitable thickness on the substrate to provide the desired amount or loading of metallic zinc on the anode.

In some embodiments, the anode 13 can comprise a metallic zinc substrate with a coating layer. The use of a coating layer on the surface of the metallic zinc can be used to prevent the corrosion of the zinc and provide access to a high fraction of the theoretical capacity (50-100%) of the zinc. This surface layer serve to protect the electroactive material from the electrolyte. The materials for the coating layer include but are not limited to pure element, oxide, or hydroxide of bismuth, indium, calcium, barium, magnesium, silver, lead, cadmium, tin, titanium, iron, aluminum, or any combinations thereof. The coating layer on the zinc substrate can be applied by methods include but not limited to electrodeposition, electroplating, and electroless plating. In some embodiments, the coating layer or a precursor thereto can be placed directly on the zinc in the electrode. For example, the additive can be formed into a paste and pasted on the zinc. Once formed, the electrode with the additive can then be cycled to reduce the coating to a form the coating layer on the zinc. This coating layer is added to stabilize the zinc electrode structure, to suppress self-discharging, to mitigate the passivation and shape change problem, or to stop the dendrites formation.

The porous anode can be constructed into different structures, including but are not limited to an expanded mesh, woven mesh, patterned mesh, foam, foil, perforated foil, patterned foil, pierced foil, wire screen, wire cloth, twisted metal, hexagonal netting, or any combination thereof. The anode structure can be used as a single layer, or as a plurality of layers, for example, by attaching several layers together through welding, pressing, folding (e.g., folding one or more sheets into several layers, etc.), or any combination thereof.

In some embodiments, the anode structure can be applied by itself or applied together with one or more optional current collectors and/or current collector tabs. A current collector can be formed from a conductive material that serves as an electrical connection between the electroactive material in the anode (e.g., the zinc) and an external electrical connection or connections. In some embodiments, the anode current collector 4 can be, for example, nickel, steel (e.g., stainless steel, etc.), nickel-coated steel, nickel plated copper, tin-coated steel, copper plated nickel, copper coated steel, silver coated copper, copper, magnesium, aluminum, tin, iron, platinum, silver, gold, titanium, half nickel and half copper, or any combination thereof. The cathode current collector may be formed into a mesh (e.g., an expanded mesh, woven mesh, etc.), perforated metal, foam, foil, perforated foil, wire screen, a wrapped assembly, or any combination thereof. In some embodiments, the current collector can be formed into or form a part of a pocket assembly. A tab (e.g., a portion of the cathode current collector 4 extending outside of the anode 13 (e.g., tab 30 as shown in FIG. 3) can be coupled to the current collector 4 to provide an electrical connection between an external source and the current collector 4.

When assembled as one or more layers of the electrode structure, an optional current collector, and an optional tab, the thickness of the porous zinc electrode can vary from as thin as about 10 μm to as thick as about 5 mm. The porosity of the electrode can vary from as high as 90% to as low as 1%. When holes are present in the electrode (e.g., with a perforated foil, a pierced foil, etc.), the holes can have a hole diameter between about 10 μm and about 1 cm. The areal density of the electrode sheet can vary from 0.7 mg/cm² to 3.5 g/cm².

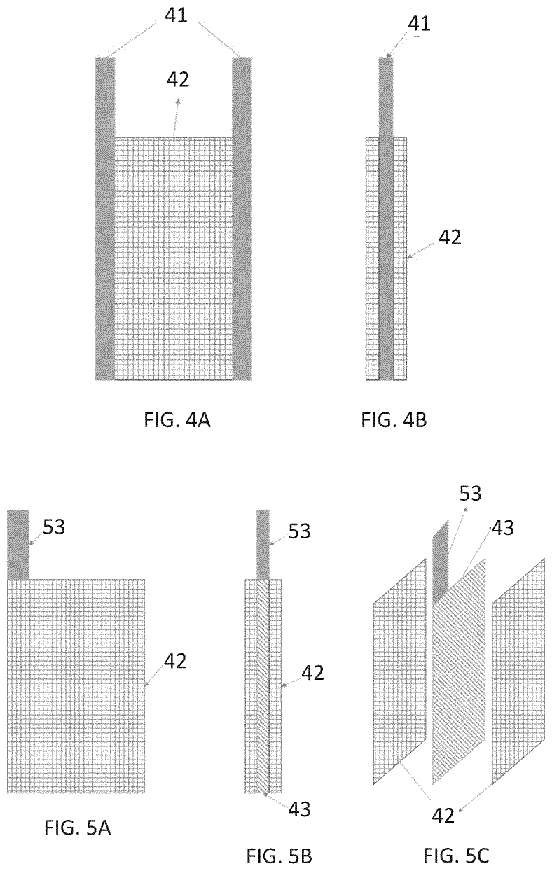

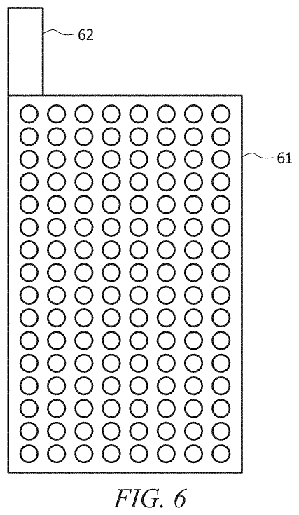

Specific examples of porous zinc electrodes can include between 1 and 6 layers of pure zinc layers (e.g., a zinc mesh, foil, screen, etc.), which can be coupled together (e.g., welded together) and applied alone as the electrode without any current collectors. The ability to avoid the use of a separate current collector outside of the zinc layers or elements may allow for reduced cost and weight for the resulting battery. In some embodiments, between 1 and 6 layers of pure zinc layers (e.g., a zinc mesh, foil, screen, etc.) 42 can be coupled together (e.g., welded together, folded together, folded at the edges, etc.) as the zinc electrode and one or more metallic tabs 41 can be welded at the edges of the zinc layers between the top and the bottom as shown in FIGS. 4A-4B. The metal of the metallic tabs 41 can include any of the metals described with respect to the current collector. In some embodiments, between 1 and 6 layers of pure zinc 42 (e.g., a zinc mesh, foil, screen, etc.) can be welded together with one layer of a metal current collector 43 (e.g., present as a mesh, foil, screen, etc.) enclosed between at least two layers of the zinc 42. The metal current collector 43 can serve as a current collector and can be formed from any of the materials described with respect to the anode current collector (e.g., including copper, etc.). Optionally, one or more tabs 53 of the same or a different material (e.g., including any of the materials used to form the current collector) can be coupled (e.g., welded, pressed, etc.) at the corner of the metal current collector 43 and/or the overall mesh stack as shown in FIGS. 5A-5C. In some embodiments, a perforated zinc foil 61 can be coupled (e.g., welded, pressed, etc.) with a tab 62 formed from any of the materials described as forming the current collector (including, for example, copper) as shown in FIG. 6 is used as the electrode.

Returning to FIGS. 1 and 2, the porous zinc electrode in the present devices and methods can be paired with various cathodes 12. The cathode 12 can comprise a mixture of components including an electrochemically active material, a binder, a conductive material, and one or more additional components that can serve to improve the lifespan, rechargeability, and electrochemical properties of the cathode 12. The cathode 12 can be incorporated into the battery 10. The cathode can comprise an active cathode material (e.g., an electroactive material). Suitable materials can include, but are not limited to, manganese oxide, manganese dioxide, copper manganese oxide, hausmannite, manganese oxide, copper intercalated bismuth birnessite, birnessite, todokorite, ramsdellite, pyrolusite, pyrochroite, nickel hydroxide, sintered nickel, nickel oxyhydroxide, potassium permanganate, cobalt oxide, silver oxide, silver, lithium manganese oxide, lithium manganese nickel cobalt oxide, lithium iron phosphate, copper oxide, manganese oxide, lithium vanadium phosphate, vanadium phosphate, vanadium pentoxide, nickel, copper, copper hydroxide, lead, lead hydroxide, lead oxide, zinc intercalating materials, or a combination thereof. In some embodiments, the cathode can be an air electrode and/or carbon electrode.

In some embodiments, the active cathode material can based on one or many polymorphs of MnO₂, including electrolytic (EMD), α-MnO₂, β-MnO₂, γ-MnO₂, δ-MnO₂, ε-MnO₂, or λ-MnO₂. Other forms of MnO₂ can also be present such as pyrolusite, ramsdellite, nsutite, manganese oxyhydroxide (MnOOH), α-MnOOH, γ-MnOOH, β-MnOOH, manganese hydroxide [Mn(OH)₂], partially or fully protonated manganese dioxide, Mn₃O₄, Mn₂O₃, bixbyite, MnO, lithiated manganese dioxide, zinc manganese dioxide. In general the cycled form of manganese dioxide in the cathode can have a layered configuration, which in some embodiment can comprise δ-MnO₂ that is interchangeably referred to as birnessite. If non-birnessite polymorphic forms of manganese dioxide are used, these can be converted to birnessite in-situ by one or more conditioning cycles as described in more details below. For example, a full or partial discharge to the end of the MnO₂ second electron stage (e.g., between about 20% to about 100% of the 2^{nd} electron capacity of the cathode) may be performed and subsequently recharging back to its Mn⁴⁺ state, resulting in birnessite-phase manganese dioxide.

The addition of a conductive additive such as conductive carbon enables high loadings of an electroactive material in the cathode material, resulting in high volumetric and gravimetric energy density. The conductive carbon can be present in a concentration between about 1-30 wt %. Such conductive carbon include single walled carbon nanotubes, multi-walled carbon nanotubes, graphene, carbon blacks of various surface areas, and others that have specifically very high surface area and conductivity. Higher loadings of the electroactive material in the cathode are, in some embodiments, desirable to increase the energy density. Other examples of conductive carbon include TIMREX Primary Synthetic Graphite (all types), TIMREX Natural Flake Graphite (all types), TIMREX MB, MK, MX, KC, B, LB Grades (examples, KS15, KS44, KC44, MB15, MB25, MK15, MK25, MK44, MX15, MX25, BNB90, LB family) TIMREX Dispersions; ENASCO 150G, 210G, 250G, 260G, 350G, 150P, 250P; SUPER P, SUPER P Li, carbon black (examples include Ketjenblack EC-300J, Ketjenblack EC-600JD, Ketjenblack EC-600JD powder), acetylene black, carbon nanotubes (single or multi-walled), carbon nanotubes plated with metal like nickel and/or copper, graphene, graphyne, graphene oxide, Zenyatta graphite, and combinations thereof. When the electroactive material comprises manganese, the birnessite discharge reaction comprises a dissolution-precipitation reaction where Mn³⁺ ions become soluble and precipitate out on the conductive carbon as Mn²⁺. This second electron process involves the formation of a non-conductive manganese hydroxide [Mn(OH)₂] layer on the conductive graphite.

The conductive additive can have a particle size range from about 1 to about 50 microns, or between about 2 and about 30 microns, or between about 5 and about 15 microns. In an embodiment, the conductive additive can include expanded graphite having a particle size range from about 10 to about 50 microns, or from about 20 to about 30 microns. In some embodiments, the mass ratio of graphite to the conductive additive can range from about 5:1 to about 50:1, or from about 7:1 to about 28:1. The total carbon mass percentage in the cathode paste can range from about 5% to about 30% or between about 10% to about 20%.

The addition of a conductive component such as metal additives to the cathode material may be accomplished by addition of one or more metal powders such as nickel powder to the cathode mixture. The conductive metal component can be present in a concentration of between about 0-30 wt %. The conductive metal component may be, for example, nickel, copper, silver, gold, tin, cobalt, antimony, brass, bronze, aluminum, calcium, iron or platinum. In one embodiment, the conductive metal component is a powder. In one embodiment, a second conductive metal component is added to act as a supportive conductive backbone for the first and second electron reactions to take place. The second electron reaction has a dissolution-precipitation reaction where Mn⁺ ions become soluble in the electrolyte and precipitate out on the graphite resulting in an electrochemical reaction and the formation of manganese hydroxide [Mn(OH)₂] which is non-conductive. This ultimately results in a capacity fade in subsequent cycles. Suitable second component include transition metals like Ni, Co, Fe, Ti and metals like Ag, Au, Al, Ca. Salts or such metals are also suitable. Transition metals like Co also help in reducing the solubility of Mn⁺ ions. Such conductive metal components may be incorporated into the electrode by chemical means or by physical means (e.g. ball milling, mortar/pestle, spex mixture). An example of such an electrode comprises 5-95% birnessite, 5-95% conductive carbon, 0-50% second conductive metal component and 1-10% binder.

In some embodiments a binder can be used in the cathode material. The binder can be present in a concentration of between about 0-10 wt % of the cathode material. In some embodiments, the binder comprises water-soluble cellulose-based hydrogels, which were used as thickeners and strong binders, and have been cross-linked with good mechanical strength and with conductive polymers. The binder may also be a cellulose film sold as cellophane. The binders were made by physically cross-linking the water-soluble cellulose-based hydrogels with a polymer through repeated cooling and thawing cycles. In one embodiment, 0-10 wt. % carboxymethyl cellulose (CMC) solution was cross-linked with 0-10 wt. % polyvinyl alcohol (PVA) on an equal volume basis. The binder, compared to the traditionally-used TEFLON®, shows superior performance. TEFLON® is a very resistive material, but its use in the industry has been widespread due to its good rollable properties. This, however, does not rule out using TEFLON® as a binder. Mixtures of TEFLON® with the aqueous binder and some conductive carbon were used to create rollable binders. Using the aqueous-based binder helps in achieving a significant fraction of the two electron capacity with minimal capacity loss over many cycles. In one embodiment, the binder is water-based, has superior water retention capabilities, adhesion properties, and helps to maintain the conductivity relative to an identical cathode using a TEFLON® binder instead. Examples of hydrogels include methyl cellulose (MC), carboxymethyl cellulose (CMC), hydroypropyl cellulose (HPH), hydroypropylmethyl cellulose (HPMC), hydroxethylmethyl cellulose (HEMC), carboxymethylhydroxyethyl cellulose and hydroxyethyl cellulose (HEC). Examples of crosslinking polymers include polyvinyl alcohol, polyvinylacetate, polyaniline, polyvinylpyrrolidone, polyvinylidene fluoride and polypyrrole. In one such embodiment, a 0-10 wt % solution of water-cased cellulose hydrogen is cross linked with a 0-10% wt solution of crosslinking polymers by, for example, repeated freeze/thaw cycles, radiation treatment or chemical agents (e.g. epichlorohydrin). The aqueous binder may be mixed with 0-5% TEFLON® to improve manufacturability.

Additional elements can be included in the cathode material including a bismuth compound and/or copper/copper compounds, which together allow improved galvanostatic battery cycling of the cathode. When present as birnessite, the copper and/or bismuth can be incorporated into the layered nanostructure of the birnessite. The resulting birnessite cathode material can exhibit improved cycling and long term performance with the copper and bismuth incorporated into the crystal and nanostructure of the birnessite.

The bismuth compound can be incorporated into the cathode 12 as an inorganic or organic salt of bismuth (oxidation states 5, 4, 3, 2, or 1), as a bismuth oxide, or as bismuth metal (i.e. elemental bismuth). The bismuth compound can be present in the cathode material at a concentration between about 1-20 wt %. Examples of inorganic bismuth compounds include bismuth chloride, bismuth bromide, bismuth fluoride, bismuth iodide, bismuth sulfate, bismuth nitrate, bismuth trichloride, bismuth citrate, bismuth telluride, bismuth selenide, bismuth subsalicylate, bismuth neodecanoate, bismuth carbonate, bismuth subgallate, bismuth strontium calcium copper oxide, bismuth acetate, bismuth trifluoromethanesulfonate, bismuth nitrate oxide, bismuth gallate hydrate, bismuth phosphate, bismuth cobalt zinc oxide, bismuth sulphite agar, bismuth oxychloride, bismuth aluminate hydrate, bismuth tungsten oxide, bismuth lead strontium calcium copper oxide, bismuth antimonide, bismuth antimony telluride, bismuth oxide yittia stabilized, bismuth-lead alloy, ammonium bismuth citrate, 2-napthol bismuth salt, duchloritri(o-tolyl)bismuth, dichlordiphenyl(p-tolyl)bismuth, triphenylbismuth.

The copper compound can be incorporated into the cathode 12 as an organic or inorganic salt of copper (oxidation states 1, 2, 3, or 4), as a copper oxide, or as copper metal (i.e., elemental copper). The copper compound can be present in a concentration between about 1-70 wt %. In one embodiment, the copper compound is present in a concentration between about 5-50 wt %. In another embodiment, the copper compound is present in a concentration between about 10-50 wt %. In yet another embodiment, the copper compound is present in a concentration between about 5-20 wt %. Examples of copper compounds include copper and copper salts such as copper aluminum oxide, copper (I) oxide, copper (II) oxide and/or copper salts in a +1, +2, +3, or +4 oxidation state including, but not limited to, copper nitrate, copper sulfate, copper chloride, etc. The effect of copper is to alter the oxidation and reduction voltages of bismuth. This results in a cathode with full reversibility during galvanostatic cycling, as compared to a bismuth-modified MnO₂ which will not withstand galvanostatic cycling.

The cathodes 12 can be produced using methods implementable in large-scale manufacturing. For a MnO₂ cathode, the cathode 12 can be capable of delivering the full second electron capacity of 617 mAh/g of the MnO₂. Excellent rechargeable performance can be achieved for both low and high loadings of MnO₂ in the mixed material, allowing the cell/battery to achieve very high practical energy densities.

The cathode material 2 can be formed on a cathode current collector 1 formed from a conductive material that serves as an electrical connection between the cathode material and an external electrical connection or connections. In some embodiments, the cathode current collector 1 can be, for example, nickel, steel (e.g., stainless steel, etc.), nickel-coated steel, nickel plated copper, tin-coated steel, copper plated nickel, silver coated copper, copper, magnesium, aluminum, tin, iron, platinum, silver, gold, titanium, half nickel and half copper, or any combination thereof. The cathode current collector may be formed into a mesh (e.g., an expanded mesh, woven mesh, etc.), perforated metal, foam, foil, perforated foil, wire screen, a wrapped assembly, or any combination thereof. In some embodiments, the current collector can be formed into or form a part of a pocket assembly. A tab (e.g., a portion of the cathode current collector 1 extending outside of the cathode material 2 as shown at the top of the cathode 12 in FIG. 1A) can be coupled to the current collector to provide an electrical connection between an external source and the current collector.

In some embodiments, the cathode material 2 can be adhered to the cathode current collector 1 by pressing at, for example, a pressure between 1,000 psi and 20,000 psi (between 6.9×10⁶ and 1.4×10⁸ Pascals). The cathode material 2 may be adhered to the cathode current collector 1 as a paste in some embodiments and/or as a film of cathode material.

In some embodiments, a separator can be disposed between the anode 13 and the cathode 12 when the electrodes are constructed into the battery. The separator 3 may comprise one or more layers. Suitable layers can include, but are not limited to, a polymeric separator layer such as a sintered polymer film membrane, polyolefin membrane, a polyolefin nonwoven membrane, a cellulose membrane, a cellophane, a battery-grade cellophane, a hydrophilically modified polyolefin membrane, and the like, or combinations thereof. As used herein, the phrase “hydrophilically modified” refers to a material whose contact angle with water is less than 45°. In another embodiment, the contact angle with water is less than 30°. In yet another embodiment, the contact angle with water is less than 20°. The polyolefin may be modified by, for example, the addition of TRITON X100™ or oxygen plasma treatment. In some embodiments, the separator 3 can comprise a CELGARD® brand microporous separator. In an embodiment, the separator 3 can comprise a FS 2192 SG membrane, which is a polyolefin nonwoven membrane commercially available from Freudenberg, Germany. In some embodiments, the separator can comprise a lithium super ionic conductor (LISICON®), sodium super ionic conductions (NASICON), NAFION®, a bipolar membrane, water electrolysis membrane, a composite of polyvinyl alcohol and graphene oxide, polyvinyl alcohol, crosslinked polyvinyl alcohol, or a combination thereof. In some embodiments, the separator membranes may be membranes fabricated from nylon, polyester, polyethylene, polypropylene, poly(tetrafluoroethylene) (PTFE), poly(vinyl chloride) (PVC), polyvinyl alcohol, cellulose or combinations thereof.

In some embodiments, an optional ion selective layer can be used with the separator layer to provide selective control of the transport of certain ions. In some embodiments, a selective layer can comprise inorganic materials including water insoluble hydroxides of metals selected from the alkaline earth metal group. Suitable metal hydroxides can include, but are not limited to, magnesium hydroxide, calcium hydroxide, strontium hydroxide, barium hydroxide, or any combination thereof. The inorganic materials can be formed into a selective layer using a binder. Any suitable binder can be used, including those described herein for use with the anode material and/or the cathode material. Suitable binders can include, but are not limited to, polytetrafluoroethylene, polyvinyl alcohol (PVA), polytetrafluoroethylene (PTFE), carboxymethyl cellulose (CMC), or any combination thereof. A resulting free-standing layer can then be formed and used with the separator. When present, the selective layer can be placed next to the zinc surface (e.g., between the surface of the metallic zinc and one or more separator layers. In some embodiments, the metallic zinc can be laminated and/or enclosed within one or more layers of the selective layer.

The zinc electrode in the present devices and methods can be applied in both aqueous systems and nonaqueous systems. The aqueous electrolytes include but are not limited to alkaline electrolyte, neutral electrolyte, acidic electrolyte, aqueous gelled electrolyte. In some embodiments, the electrolyte can comprise an alkaline electrolyte (e.g. an alkaline hydroxide, such as NaOH, KOH, LiOH, ammonium hydroxide, or mixtures thereof). In some embodiments, the electrolyte can comprise an acidic solution, alkaline solution, ionic liquid, organic-based, solid-phase, gelled, etc. or combinations thereof that conducts lithium, magnesium, aluminum and zinc ions. Examples include chlorides, sulfates, sodium hydroxide, potassium hydroxide, lithium hydroxide, ammonium hydroxide, perchlorates like lithium perchlorate, magnesium perchlorate, aluminum perchlorate, lithium hexafluorophosphate, [M⁺][AlCl⁴⁻](M⁺)]-sulphonyl chloride or phosphoryl chloride cations, 1-ethyl-3-methylimidazolium bis(trifluoromethylsulfonyl)imide, 1-ethyl-3-methylimidazolium trifluoromethanesulfonate, 1-butyl-1-methylpyrrolidinium bis(trifluoromethylsulfonyl)imide, 1-hexyl-3-methylimidazolium hexofluorophosphate, 1-ethyl-3-methylimidazolium dicyanamide, 11-methyl-3-octylimidazolium tetrafluoroborate, yttria-stabilized zirconia, beta-alumina solid, polyacrylamides, NASICON, lithium salts in mixed organic solvents like 1,2-dimethoxyethane, propylene carbonate, magnesium bis(hexamethyldisilazide) in tetrahydrofuran and a combination thereof. In some embodiments, the electrolyte can comprise manganese sulfate, manganese chloride, manganese nitrate, manganese perchlorate, manganese acetate, manganese bis(trifluoromethanesulfonate), manganese triflate, manganese carbonate, manganese oxalate, manganese fluorosilicate, manganese ferrocyanide, manganese bromide, nitric acid, sulfuric acid, hydrochloric acid, sodium sulfate, potassium sulfate, sodium hydroxide, sodium hydroxide with dissolved zincate ions, potassium hydroxide, potassium hydroxide with dissolved zincate ions potassium permanganate, titanium sulfate, titanium chloride, lithium nitrate, lithium chloride, lithium bromide, lithium bicarbonate, lithium acetate, lithium sulfate, lithium permanganate, lithium nitrate, lithium nitrite, lithium hydroxide, lithium hydroxide with dissolved zincate ions, lithium perchlorate, lithium oxalate, lithium fluoride, lithium carbonate, lithium bromate, zinc sulfate, zinc chloride, zinc acetate, zinc carbonate, zinc chlorate, zinc fluoride, zinc formate, zinc nitrate, zinc oxalate, zinc sulfite, zinc tartrate, zinc cyanide, zinc oxide, or a combination thereof. The pH of the electrolyte can vary from 0-15. Suitable nonaqueous electrolytes can include, but are not limited to, organic electrolyte, ionic liquid, polymer solid electrolytes, and combinations thereof.

The resulting electrode can then be cycled within the electrolyte or removed and used in a battery. When used as a secondary battery, the battery 10 can be cycled during use by being charged and discharged. In some embodiments, the zinc electrode can be cycling with an electrolytic manganese dioxide cathode (EMD) within the 1^{st} electron capacity of MnO₂, with concentrated potassium hydroxide solution as the electrolyte. In some embodiments, the zinc electrode is cycling with a birnessite cathode within the 2^{nd} electron capacity of MnO₂, with concentrated potassium hydroxide solution as the electrolyte.

### EXAMPLES

The embodiments having been generally described, the following examples are given as particular embodiments of the disclosure and to demonstrate the practice and advantages thereof. It is understood that the examples are given by way of illustration and are not intended to limit the specification or the claims in any manner.

### Example 1

An alkaline Zn/MnO₂ cylindrical cell was fabricated. The cathode material was mainly electrolytic MnO₂ with conductive carbon and binders. The anode was fabricated by welding 6 layers of pure zinc mesh with 1 layer of copper mesh in the center. The anode was approximately 6″ wide and 50″ long. The cathode sheet and anode sheet were laminated together with several layers of separators comprising cellophane and polyvinyl alcohol films, and the laminate was then jelly rolled into a cylindrical cell pack. 30 wt. % KOH was used as the electrolyte.

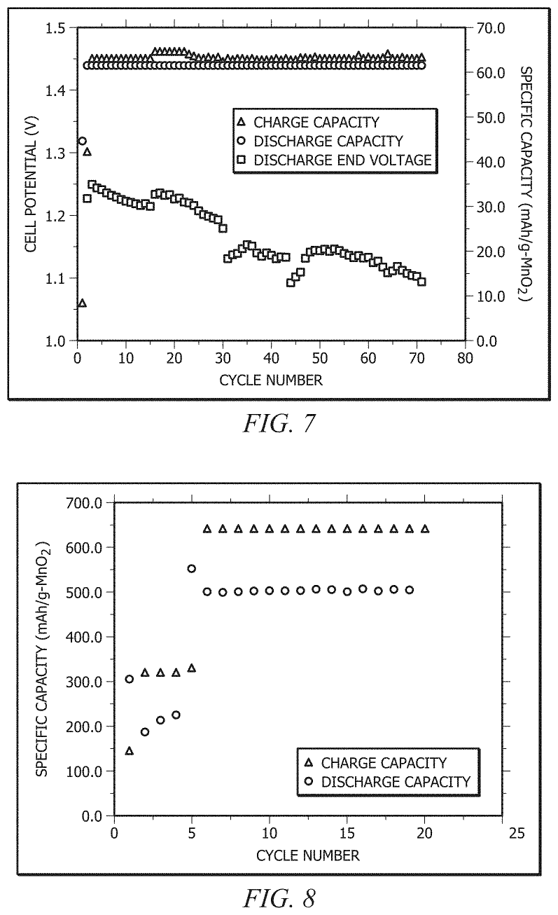

The cell was cycled at a fast rate of C/20 (C equals the 1^{st} electron capacity of MnO₂). The depth of discharge (DOD) was around 20% of MnO₂ (1^{st} electron capacity) and 13% of Zn. With this high rate and high utilization of the Zn electrode, the cell was able to cycle stably, achieving the desired capacity with a discharge end voltage similar with cells containing pasted zinc electrode at a lower DOD of 9%. The results are shown in FIG. 7.

### Example 2

An alkaline Zn/MnO₂ prismatic cell was fabricated. The cathode material was mainly electrolytic MnO₂ with conductive carbon and additives including bismuth, copper and their oxide phases to stabilize the MnO₂ structure. The anode was fabricated by welding 6 layers of pure zinc mesh with 1 layer of copper mesh in center. One layer of a calcium hydroxide sheet fabricated from calcium hydroxide powers and binder was inserted in between the anode and the separator at each side, to suppress the zinc dendritic growth and reduce its shape change. The electrodes were in the size of 2″ by 3″. The cell was first cycled in the 1^{st} electron capacity region of MnO₂ between 0.9 V to 1.75 V for 5 cycles to stabilize the electrode material structures, and then switched to the 2^{nd} electron region cycling from 0.3 V to 1.75 V.

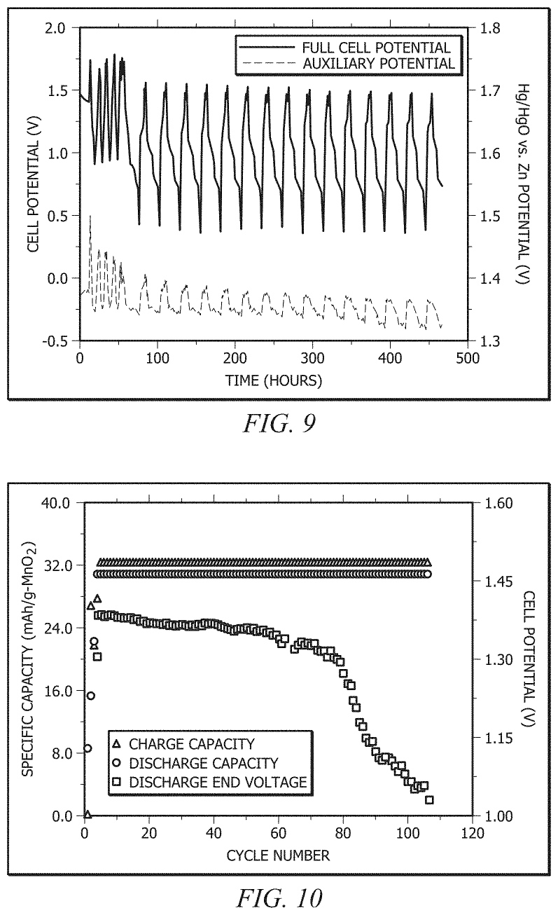

With the help of bismuth and copper, the EMD material, after a complete discharge of its full 2-electron capacity, is converted to a different phase, e.g., birnessite, which has a layered structure. The additives further stabilize this layered structure and enable long-term cycling of the MnO₂ material with a high utilization of its 2-electron capacity. As shown in FIG. 8, the cell is stably running, achieving a specific discharge capacity around 500 mAh/g-MnO₂. The full cell potential curve and the zinc anode auxiliary voltage curve as monitored with a Hg/HgO reference electrode are shown in FIG. 9. A very stable potential of the cell is maintained while the cell is being cycling at a DOD as high as 81% of the MnO₂ and 14% of the Zn.

### Example 3

An alkaline Zn/MnO₂ prismatic cell was fabricated. The cathode material was mainly electrolytic MnO₂ with conductive carbon and binders. The anode was fabricated by welding 6 layers of pure zinc mesh with no current collectors. The electrodes were of the size of 2″ by 3″. The cathode sheet and anode sheet were laminated together with several layers of separators comprising cellophane and polyvinyl alcohol films. 25 wt. % KOH was used as the electrolyte.

The cell was cycled in the 1^{st} electron capacity region of MnO₂ at a depth of discharge around 10% of MnO₂ (1-electron capacity) and 20% of Zn. As shown in FIG. 10, even in the absence of a current collector, the cell is able to show a promising performance with high utilization of the Zn electrode, stably achieving the desired capacity and maintaining its discharge end voltage above 1.0 V. This result suggests that with the current electrode design, a current collector could be unnecessary, which may significantly decrease the cell cost by removing an expensive and inactive cell component.

Having described various electrodes, processes, and devices, specific embodiments can include, but are not limited to:

In a first embodiment, a battery comprises: an anode, a cathode, a separator disposed between the anode and the cathode, and an electrolyte in fluid communication with the anode, the cathode, and the separator.

A second embodiment can include the battery of the first embodiment, wherein the anode is a porous metallic zinc anode.

A third embodiment can include the battery of the second embodiment, wherein the porous metallic zinc anode comprises pure zinc electrode, a substrate coated with zinc, a zinc substrate with a coating layer, or combinations thereof.

A fourth embodiment can include the battery of the third embodiment, wherein the zinc coated electrode comprises a substrate of nickel, copper, silver, gold, platinum, titanium, tin, iron, steel, aluminum, magnesium, bismuth, polymer, or combinations thereof.

A fifth embodiment can include the battery of the third embodiment, wherein the coating layer for the zinc substrate comprises the pure element, oxide or hydroxide of bismuth, indium, calcium, barium, magnesium, silver, lead, cadmium, tin, titanium, iron, aluminum or combinations thereof.

A sixth embodiment can include the battery of any one of the second to fifth embodiments, wherein the porous metallic zinc anode is formed into an expanded mesh, woven mesh, foam, foil, perforated foil, pierced foil, wire screen, or any combination thereof.

A seventh embodiment can include the battery of any one of the second to sixth embodiments, wherein the thickness of the zinc electrode is 10 μm to 5 mm.

An eighth embodiment can include the battery of any one of the second to seventh embodiments, wherein the areal density of the zinc electrode is 0.7 mg/cm² to 3.5 g/cm².

A ninth embodiment can include the battery of any one of the second to eighth embodiments, wherein the porosity of the zinc electrode is 90% to 1%.

A tenth embodiment can include the battery of any one of the second to ninth embodiments, wherein the hole diameter of the zinc electrode is 10 μm to 1 cm.

An eleventh embodiment can include the battery of any one of the second to tenth embodiments, wherein each zinc electrode comprises at least one layer of the electrode sheet.

A twelfth embodiment can include the battery of the eleventh embodiment, wherein the electrode sheets are attached to each other by welding, pressing, by folding one sheet into several layers or any combinations thereof.

A thirteenth embodiment can include the battery of any one of the second to twelfth embodiments, wherein the electrode sheet is applied alone or applied together with one or more current collectors.

A fourteenth embodiment can include the battery of the thirteenth embodiment, wherein the current collector comprises nickel, steel, copper, magnesium, aluminum, tin, iron, platinum, silver, gold, titanium, nickel-coated steel, nickel coated copper, copper coated nickel, copper coated steel, tin coated steel, silver coated copper, or any combinations thereof.

A fifteenth embodiment can include the battery of the thirteenth or fourteenth embodiment, wherein the current collector is formed into a metal tab, an expanded mesh, woven mesh, perforated metal, foam, foil, perforated foil, wire screen, a wrapped assembly, or any combinations thereof.

A sixteenth embodiment can include the battery of any one of the thirteenth to fifteenth embodiments, wherein the electrode is attached to the current collector by welding, pressing or any combinations thereof.

A seventeenth embodiment can include the battery of any one of the first to sixteenth embodiments, wherein the cathode material is manganese oxide, nickel oxyhydroxide, silver oxide electrode, an air electrode, zinc intercalating materials, or any combinations thereof.

An eighteenth embodiment can include the battery of any one of the first to seventeenth embodiments, wherein the separator membranes are films fabricated from nylon, polyester, polyethylene, polypropylene, poly(tetrafluoroethylene) (PTFE), poly(vinyl chloride) (PVC), polyvinyl alcohol, cellulose or combinations thereof.

A nineteenth embodiment can include the battery of any one of the first to eighteenth embodiments, wherein the electrolyte is aqueous or nonaqueous.

A twentieth embodiment can include the battery of the nineteenth embodiment, wherein the aqueous electrolyte is alkaline electrolyte, neutral electrolyte, acidic electrolyte, aqueous gelled electrolyte, or any combination thereof.

A twenty first embodiment can include the battery of the nineteenth embodiment, wherein the nonaqueous electrolyte is organic electrolyte, ionic liquid, polymer solid electrolyte, or combinations thereof.

A twenty second embodiment can include the battery of any one of the first to twenty first embodiments, wherein the battery cell is a prismatic cell or a jelly rolled cell.

A twenty third embodiment can include the battery of any one of the first to twenty second embodiments, wherein the battery is a primary battery or a secondary battery.

Embodiments are discussed herein with reference to the Figures. However, those skilled in the art will readily appreciate that the detailed description given herein with respect to these figures is for explanatory purposes as the systems and methods extend beyond these limited embodiments. For example, it should be appreciated that those skilled in the art will, in light of the teachings of the present description, recognize a multiplicity of alternate and suitable approaches, depending upon the needs of the particular application, to implement the functionality of any given detail described herein, beyond the particular implementation choices in the following embodiments described and shown. That is, there are numerous modifications and variations that are too numerous to be listed but that all fit within the scope of the present description. Also, singular words should be read as plural and vice versa and masculine as feminine and vice versa, where appropriate, and alternative embodiments do not necessarily imply that the two are mutually exclusive.

It is to be further understood that the present description is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present systems and methods. It must be noted that as used herein and in the appended claims (in this application, or any derived applications thereof), the singular forms “a,” “an,” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this description belongs. Preferred methods, techniques, devices, and materials are described, although any methods, techniques, devices, or materials similar or equivalent to those described herein may be used in the practice or testing of the present systems and methods. Structures described herein are to be understood also to refer to functional equivalents of such structures. The present systems and methods will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims may be formulated in this Application or of any further Application derived therefrom, to particular combinations of features, it should be understood that the scope of the disclosure also includes any novel feature or any novel combination of features disclosed herein either explicitly or implicitly or any generalization thereof, whether or not it relates to the same systems or methods as presently claimed in any Claim and whether or not it mitigates any or all of the same technical problems as do the present systems and methods.

Features which are described in the context of separate embodiments may also be provided in combination in a single embodiment. Conversely, various features which are, for brevity, described in the context of a single embodiment, may also be provided separately or in any suitable sub-combination. The Applicants hereby give notice that new claims may be formulated to such features and/or combinations of such features during the prosecution of the present Application or of any further Application derived therefrom.

What is claimed is:

1. A battery comprising:
an anode, wherein the anode is a porous metallic zinc anode;
a cathode;
a separator disposed between the anode and the cathode; and
an electrolyte in fluid communication with the anode, the cathode, and the separator.

2. The battery of claim 1, wherein the porous metallic zinc anode comprises a pure zinc electrode, a substrate coated with zinc, a zinc substrate with a coating layer, or combinations thereof.

3. The battery of claim 1, wherein the porous metallic zinc anode comprises a substrate coated with zinc, and wherein the substrate comprises nickel, copper, silver, gold, platinum, titanium, tin, iron, steel, aluminum, magnesium, bismuth, polymer, or combinations thereof.

4. The battery of claim 1, wherein the porous metallic zinc anode comprises a zinc substrate with a coating layer, wherein the coating layer for the zinc substrate comprises an element, oxide, or hydroxide of: bismuth, indium, calcium, barium, magnesium, silver, lead, cadmium, tin, titanium, iron, aluminum, or combinations thereof.

5. The battery of claim 1, wherein the porous metallic zinc anode is formed as an expanded mesh, woven mesh, foam, foil, perforated foil, pierced foil, wire screen, or any combination thereof.

6. The battery of claim 1, wherein a thickness of the zinc electrode is between 10 μm and 5 mm.

7. The battery of claim 1, wherein the areal density of the zinc electrode is between 0.7 mg/cm² and 3.5 g/cm².

8. The battery of claim 1, wherein the porosity of the zinc electrode is between 90% and 1%.

9. The battery of claim 1, wherein the zinc electrode comprises one or more holes, and wherein a diameter of the one or more holes is between 10 μm and 1 cm.

10. The battery of claim 1, wherein the zinc electrode comprises at least one layer of a zinc electrode sheet.

11. The battery of claim 10, wherein the zinc electrode sheet is electrically coupled to one or more current collectors.

12. The battery of claim 11, wherein the one or more current collectors comprise nickel, steel, copper, magnesium, aluminum, tin, iron, platinum, silver, gold, titanium, nickel-coated steel, nickel coated copper, copper coated nickel, copper coated steel, tin coated steel, silver coated copper, or any combinations thereof.

13. The battery of claim 11, wherein the current collector is in the form of a metal tab, an expanded mesh, woven mesh, perforated metal, foam, foil, perforated foil, wire screen, a wrapped assembly, or any combinations thereof.

14. The battery of claim 11, wherein the zinc electrode sheet is attached to the current collector by welding, pressing, or any combinations thereof.

15. The battery of claim 1, wherein the zinc electrode comprises a plurality of layers of zinc electrode sheets, wherein the plurality of zinc electrode sheets are attached to each other by a weld, a press fitting, by one or more folds, or any combinations thereof.

16. The battery of claim 1, wherein the cathode comprises a cathode material, and wherein the cathode material comprises manganese oxide, nickel oxyhydroxide, silver oxide electrode, an air electrode, zinc intercalating materials, or any combinations thereof.

17. The battery of claim 1, wherein the separator comprises a membrane, and wherein the membrane is a film fabricated from nylon, polyester, polyethylene, polypropylene, poly(tetrafluoroethylene) (PTFE), poly(vinyl chloride) (PVC), polyvinyl alcohol, cellulose, or combinations thereof.

18. The battery of claim 1, wherein the electrolyte is an aqueous or a nonaqueous electrolyte.

19. The battery of claim 18, wherein the aqueous electrolyte is an alkaline electrolyte, a neutral electrolyte, an acidic electrolyte, an aqueous gelled electrolyte, or a combination thereof.

20. The battery of claim 18, wherein the nonaqueous electrolyte is an organic electrolyte, an ionic liquid, a polymer solid electrolyte, or any combination thereof.

21. An anode comprising:
at least one layer comprising a porous metallic zinc,
wherein the porous metallic zinc comprises a pure zinc electrode, a substrate coated with zinc, a zinc substrate with a coating layer, or combinations thereof, and
wherein the porous metallic zinc is formed into an expanded mesh, woven mesh, foam, foil, perforated foil, pierced foil, wire screen, or any combination thereof.

22. (canceled)

23. The anode of claim 21, wherein the porous metallic zinc comprises a substrate coated with zinc, and wherein the substrate comprises nickel, copper, silver, gold, platinum, titanium, tin, iron, steel, aluminum, magnesium, bismuth, polymer, or combinations thereof.

24. The anode of claim 21, wherein the porous metallic zinc comprises a zinc substrate with a coating layer, wherein the coating layer for the zinc substrate comprises an element, oxide, or hydroxide of: bismuth, indium, calcium, barium, magnesium, silver, lead, cadmium, tin, titanium, iron, aluminum, or combinations thereof.

25. The anode of claim 21, wherein the areal density of the zinc electrode is between 0.7 mg/cm² and 3.5 g/cm².

26. The anode of claim 21, wherein the porosity of the zinc electrode is between 90% and 1%.

27. The anode of claim 21, wherein the zinc electrode comprises at least one layer of a zinc electrode sheet.

28. The anode of claim 27, wherein the zinc electrode sheet is electrically coupled to one or more current collectors.

29. The anode of claim 28, wherein the one or more current collectors comprise nickel, steel, copper, magnesium, aluminum, tin, iron, platinum, silver, gold, titanium, nickel-coated steel, nickel coated copper, copper coated nickel, copper coated steel, tin coated steel, silver coated copper, or any combinations thereof.

30. The anode of claim 28, wherein the current collector is in the form of a metal tab, an expanded mesh, woven mesh, perforated metal, foam, foil, perforated foil, wire screen, a wrapped assembly, or any combinations thereof.

31. The anode of claim 28, wherein the zinc electrode sheet is attached to the current collector by welding, pressing, or any combinations thereof.

32. The anode of claim 21, wherein the zinc electrode comprises a plurality of layers of zinc electrode sheets, wherein the plurality of zinc electrode sheets are attached to each other by a weld, a press fitting, by one or more folds, or any combinations thereof.

33. A method of forming a battery, the method comprising:
providing an anode comprising at least one layer comprising a porous metallic zinc, wherein the porous metallic zinc anode comprises a pure zinc electrode, a substrate coated with zinc, a zinc substrate with a coating layer, or combinations thereof, and wherein the porous metallic zinc anode is formed into an expanded mesh, woven mesh, foam, foil, perforated foil, pierced foil, wire screen, or any combination thereof;
providing a cathode;
disposing a separator between the anode and the cathode in a housing; and
disposing an electrolyte within the housing in contact with the anode, the cathode, and the separator.

34.-35. (canceled)

36. The method of claim 33, wherein the anode comprises one or more current collectors.

37. The method of claim 36, wherein the one or more current collectors comprise nickel, steel, copper, magnesium, aluminum, tin, iron, platinum, silver, gold, titanium, nickel-coated steel, nickel coated copper, copper coated nickel, copper coated steel, tin coated steel, silver coated copper, or any combinations thereof.

38. The method of claim 36, wherein the zinc electrode sheet is attached to the current collector by welding, pressing, or any combinations thereof.

39. The method of claim 33, wherein the zinc electrode comprises a plurality of layers of zinc electrode sheets, wherein the plurality of zinc electrode sheets are attached to each other by a weld, a press fitting, by one or more folds, or any combinations thereof.

40. The method of claim 33, wherein the cathode comprises a cathode material, and wherein the cathode material comprises manganese oxide, nickel oxyhydroxide, silver oxide electrode, an air electrode, zinc intercalating materials, or any combinations thereof.
